(19) United States
(12) Patent Application Publication
(10) Pub. No.: US 2011/0287133 A1
(43) Pub. Date: Nov. 24, 2011

(54) WINE TASTING KIT

(76) Inventor: Arturo Ortega, San Diego, CA (US)

(21) Appl. No.: 13/109,817

(22) Filed: May 17, 2011

Related U.S. Application Data
(60) Provisional application No. 61/346,586, filed on May 20, 2010.

(51) Int. Cl. C12G 1/00

(52) U.S. Cl. 426/2; 426/87

(57) ABSTRACT

A wine tasting kit includes a plurality of wine bottles, each containing a different type of wine; a brochure that includes information about the different types of wine; and a container that retains the wine bottles and the brochure. There may be from 2 to 24 wine bottles, for example, 6. At least one bottle may contain red wine, and at least one bottle may contain white wine. The brochure may explain the differences between wines, aromas, varietals, taste, and color.

### RELATED APPLICATIONS

This application claims the benefit of the filing date of U.S. patent application Ser. No. 61/346,586, filed May 20, 2010, which is incorporated herein by reference in its entirety.

### BACKGROUND OF THE INVENTION

The present invention generally relates to food products and more specifically to a wine tasting kit.

The retail wine market size may be approximately $30 billion per year. Wine sold in the US may be approximately 745 million gallons. Wine imports are in the rise, up to 12%-15% per year.

According to ACNielsen, consumers drink more read wine that white. Red accounts for 43%, white accounts for 42%, and blush 15% of this market. However, 80% of wine consumers in the U.S. cannot tell the difference between Merlot and Cabernet Sauvignon.

Studies we have taken may show that price segments include: everyday beverages, 73%; luxury ($25 and over) 3%; ultra premium ($14 to $25) 7%; super premium ($7 to $14) 17%; and total shipments: 147 million cases.

It would be desirable to have a kit to educate the consumer to the basics of wine tasting, wine appreciation and proper selection of wine for food paring.

### SUMMARY OF THE INVENTION

In one aspect of the present invention, a wine tasting kit may include a plurality of wine bottles, each containing a different type of wine; a brochure that includes information about the different types of wine; and a container that retains the wine bottles and the brochure.

In another aspect of the present invention, a wine tasting kit includes a container; from 2 to 24 wine bottles, placed inside the container, each containing a different type of wine; said wines being table wines, at least one bottle containing red wine, and at least one bottle containing white wine; and at least one brochure including information about the plurality of wines, the brochure explaining the differences between wines, aromas, varietals, taste, and color.

In yet another aspect of the present invention, a method of tasting wine includes providing a plurality of wine bottles, each containing a different type of wine; providing a container; retaining the wine bottles in the container; and providing a brochure that includes information about the different types of wine.

### BRIEF DESCRIPTION OF THE DRAWINGS

FIG. 1 illustrates a wine tasting kit according to the present invention.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

Broadly, an embodiment of the present invention generally provides a wine tasting kit, which may include tips and suggestions to enable a wine consumer to learn the difference between different varieties of wine.

Embodiments of a wine tasting kit according to the present invention may enable wine consumers to learn about wines and may also allow the consumer to learn to differentiate between each variety of wine.

An embodiment of a wine tasting kit may include a container, a plurality of wine bottles placed inside the container, and at least one brochure including information about the plurality of wines. Each bottle of wine may be different from the other wine bottles.

In one embodiment, a kit may include between 2 to 24 bottles of wine. In another embodiment, the kit may include 6-12 different bottles of wine.

In one embodiment, the brochure may include tips and suggestions on how to host a wine tasting event, party, and/or activity. In another embodiment, the kit may include a brochure with information about easy steps to score the wine. In another embodiment, the kit may include wine scoring sheets and forms.

An embodiment of a brochure may provide the consumer with the basics and the secrets of wine tasting while enjoying the wine. The brochure may be broken into four sections: a “to know your wine” guide, a wine aromas section for each wine varietal, wine tasting notes for each wine varietal, and a short aroma/tasting reference guide to go through the exercise of differentiating the wine varietals.

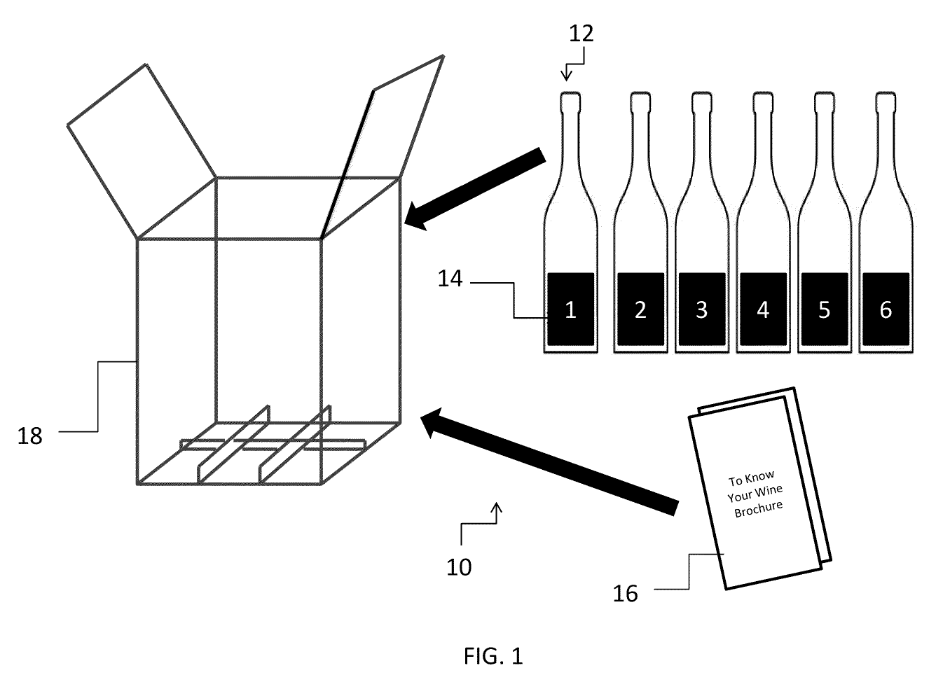

As depicted in FIG. 1, an embodiment of a wine tasting kit 10 may include a plurality of wine bottles 12, such as six bottles, each containing a different type of wine 14. A brochure 16 may include information about the different wines 14. A container 18 may retain the wine bottles and the brochure.

An embodiment of a kit according to the present invention may be a self-contained package that may include all the information and material necessary to allow the wine consumer to host, play, and/or learn about the different wines inside the kit. In addition, the kit of the present invention may become a game for the consumers.

Embodiments of the present invention may also contemplate a method to enable wine consumers to learn the differences between wines by using the kit according to the present invention.

It should be understood, of course, that the foregoing relates to exemplary embodiments of the invention and that modifications may be made without departing from the spirit and scope of the invention as set forth in the following claims.

An embodiment of a wine tasting kit may include: a container, a plurality of wine bottles placed inside the container, at least one brochure including information about the plurality of wines, and wherein each bottle of wine may be different from the other wine bottles.

I claim:

1. A wine tasting kit comprising:
a plurality of wine bottles, each containing a different type of wine;
a brochure that includes information about the different types of wine; and
a container that retains the wine bottles and the brochure.

2. The kit of claim 1, including from 2 to 24 wine bottles, each containing a different type of wine.

3. The kit of claim 1, including 6 wine bottles, each containing a different type of wine.

4. The kit of claim 1, wherein each wine bottle contains 750 ml of wine.

5. The kit of claim 1, wherein the wines are table wines.

6. The kit of claim 1, wherein at least one bottle contains red wine, and at least one bottle contains white wine.

7. The kit of claim 1, wherein the brochure describes proper selection of wine for food paring.

8. The kit of claim 1, wherein the brochure explains the differences between wines, aromas, varietals, taste, and color.

9. The kit of claim 1, wherein the brochure explains how to host a wine tasting event.

10. The kit of claim 1, further including wine tasting sheets.

11. The kit of claim 1, further including information on how to score the wines.

12. A wine tasting kit comprising:
a container;
from 2 to 24 wine bottles, placed inside the container, each containing a different type of wine;
said wines being table wines, at least one bottle containing red wine, and at least one bottle containing white wine; and
at least one brochure including information about the plurality of wines, the brochure explaining the differences between wines, aromas, varietals, taste, and color.

13. The kit of claim 12, further comprising:
wine tasting sheets; and
information on how to score the wines.

14. A method of tasting wine, comprising:
providing a plurality of wine bottles, each containing a different type of wine;
providing a container;
retaining the wine bottles in the container; and
providing a brochure that includes information about the different types of wine.
